(19) United States
(12) Patent Application Publication
(10) Pub. No.: US 2026/0084601 A1
(43) Pub. Date: Mar. 26, 2026

(54) METHOD FOR PRODUCING AN UPHOLSTERY ELEMENT FROM NONWOVEN FABRIC ELEMENTS FOR A VEHICLE SEAT, VEHICLE SEAT WITH SUCH UPHOLSTERY ELEMENT, AND MOTOR VEHICLE WITH SUCH A VEHICLE SEAT

(71) Applicant: AUDI AG, lngolstadt (DE)

(72) Inventors: Lars ELLERMANN, Weinsberg (DE); Steffen ROSS, Wettstetten (DE)

(73) Assignee: AUDI AG, lngolstadt (DE)

(21) Appl. No.: 19/305,666

(22) Filed: Aug. 20, 2025

(30) Foreign Application Priority Data
Sep. 20, 2024 (DE) 102024127184.1

(51) Int. Cl. B60N 2/70; B32B 5/02; B32B 15/14; B32B 27/12

(52) U.S. Cl. CPC B60N 2/7017; B32B 5/022; B32B 15/14; B32B 27/12; B32B 2250/03; B32B 2601/00; B32B 2605/00

(57) ABSTRACT

A method for producing an upholstery element of a vehicle seat, by providing at least two plate-like nonwoven fabric elements; inserting one or more nonwoven fabric elements into a forming tool; inserting at least one additional component made of a plastic and/or a metal and/or a textile on top of the last inserted nonwoven fabric element; inserting at least one other nonwoven fabric element into the forming tool, wherein the at least one nonwoven fabric element covers the at least one additional component; closing the forming tool and injecting a vaporous fluid, such that the nonwoven fabric elements swell and are materially bonded to one another to form an upholstery element and the at least one additional component is materially bonded in the upholstery element.

### FIELD

The invention relates to a method for producing an upholstery element of a vehicle seat, a vehicle seat with at least one such upholstery element, and a motor vehicle with at least one such vehicle seat.

### BACKGROUND

To attach a seat cover to an upholstery element made of a foamed plastic material, such as polyurethane (PU), wires are placed in the foam tool and foamed into the (PU) foam during the manufacturing process. When attaching a cover element, it is attached to the foamed-in wire with a clamp. For sustainability reasons, there are currently efforts to produce upholstery elements from fiber materials in order to avoid foamed plastics. A wire frame is attached separately to the back or B-side of the upholstery element made of fiber material, to which a cover element can then be attached.

For the state of the art, reference is made, for example, to EP 2 417 876 A1 and DE 10 2010 005 994 A1. Further background documents include U.S. Pat. No. 11,554,699 B2, US 2022 098 770 A1, WO 2020 190 831 A1, EP 3 483 002 A1, and U.S. Pat. No. 7,837,263 B2.

### SUMMARY

The object underlying the invention is to provide a method for producing an upholstery element made of fiber material, in which method a separate fastening of an additional wire frame can be eliminated.

A method for producing an upholstery element of a vehicle seat is therefore proposed, comprising the steps:
providing at least two plate-like nonwoven fabric elements;
inserting one or more nonwoven fabric element(s) into a forming tool; inserting at least one additional component made of a plastic and/or a metal and/or a textile on top of the last inserted nonwoven fabric element; inserting at least one other nonwoven fabric element into the forming tool, wherein the at least one nonwoven fabric element covers the at least one additional component; closing the forming tool and injecting a vaporous fluid, in particular water vapor, such that the nonwoven fabric elements swell and are materially bonded to one another to form an upholstery element and the at least one additional component is materially bonded in the upholstery element.

The plate-like nonwoven fabric elements can have different (technical) properties, in particular different chemical compositions and/or different plate thicknesses and/or different physical properties, such as elasticity or the like.

The process allows an additional component to be inserted and integrated directly into the upholstery element made of nonwoven fabric elements. The additional component can be made in particular as a frame made of a metallic wire or of a plastic. Alternatively or additionally, the additional component can also be a textile layer or a textile element, in particular one designed in the form of a frame which is arranged between two nonwoven fabric elements.

In the process, a preform or a final shape of the upholstery element can be formed by swelling the nonwoven fabric elements in the closed forming tool. The forming of the upholstery element occurs due to the interaction of chemical and/or physical reactions when the vaporous fluid in the closed forming tool interacts with the nonwoven fabric elements.

In the method, the upholstery element can be cut and/or pressed as a preform in a further step inside the forming tool or outside the forming tool in order to produce a final shape of the upholstery element. It is possible, for example, that tool halves of the forming tool that are movable relative to one another are further apart from one another when injecting the vaporous fluid, such that the swelling of the nonwoven fabric elements can take place to a sufficient extent, and that the tool halves are moved closer to one another after a certain period of time, in particular after the swelling of the nonwoven fabric elements, in order to be able to produce a final shape of the upholstery element.

In the method, an upholstery cover element made of a textile material and/or leather and/or plastic can be attached to the upholstery element, in particular after its removal from the forming tool, wherein the upholstery cover element is fastened by means of multiple upholstery clamps to the at least one additional component which is integrally received in the upholstery element. The additional component forms a type of reinforcement or anchoring with which the multiple upholstery clips are brought into engagement, such that the upholstery clips are prevented from tearing out of the interconnected nonwoven fabric elements.

The upholstery clips used can be made of a flat strip material, in particular flat strip steel.

With regard to such upholstery clips, particular reference is made to the application filed at the same time by the same applicant entitled “Upholstery clip made of a metallic flat strip for fastening an upholstery cover to an upholstery element of a vehicle seat, vehicle seat with such upholstery clips, and motor vehicle with such a vehicle seat.”

Also proposed is a vehicle seat having at least one upholstery element produced according to the method described above, wherein the upholstery element is a seat cushion and/or a back cushion and/or a cheek pad. Cheek pads can be understood as, for example, a lateral leg guide in the area of the seat cushion or a lateral body guide in the area of the back cushion.

Furthermore, a motor vehicle with at least one such vehicle seat is also proposed.

### BRIEF DESCRIPTION OF THE FIGURES

Further advantages and details of the invention will become apparent from the following description of embodiments with reference to the figures. In the figures:

FIG. 1 shows a method for producing an upholstery element of a vehicle seat using simplified sectional views;

FIG. 2 shows another sectional view of an optional step of the method;

FIG. 3 shows a simplified plan view of an upholstery element with additional component and schematically a vehicle seat and a motor vehicle.

### DETAILED DESCRIPTION

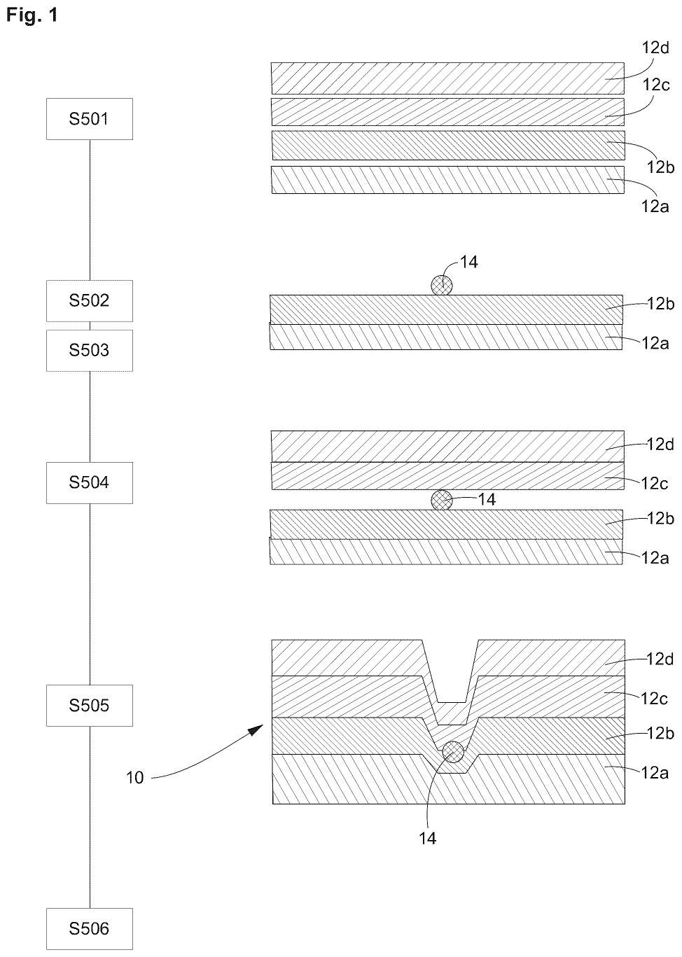

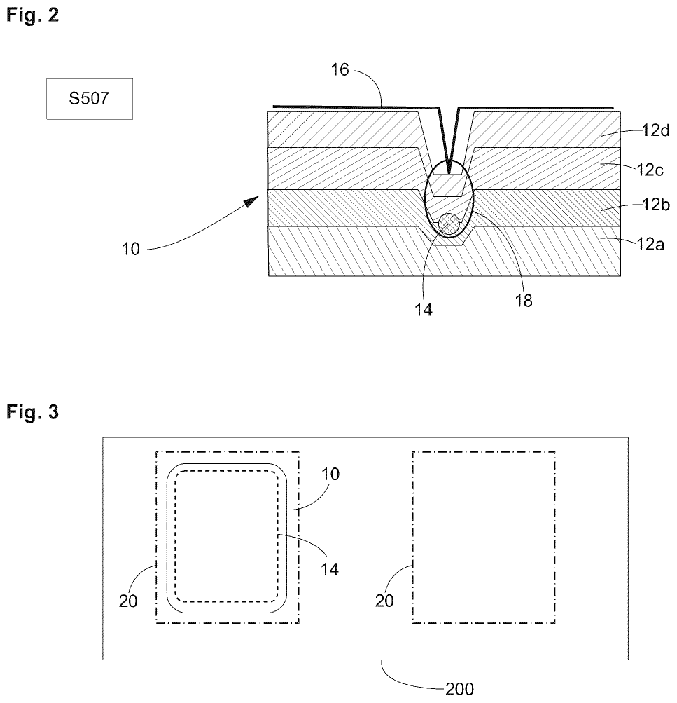

FIG. 1 shows a simplified and schematic diagram of a method 500 for producing an upholstery element 10 (FIG. 2).

According to a step S501, at least two plate-like nonwoven fabric elements 12a, 12b, 12c, 12d are provided.

According to a step S502, one of the nonwoven fabric elements or several of the nonwoven fabric elements 12a, 12b are inserted into a forming tool (not shown).

According to a step S503, at least one additional component 14 made of a plastic and/or a metal and/or a textile is inserted on top of the last inserted nonwoven fabric element 12b.

According to a step S504, at least one other nonwoven fabric element 12c, 12d is inserted into the forming tool, wherein the at least one nonwoven fabric element 12c, 12d covers the at least one additional component 14.

According to a step S505, the forming tool is closed and a vaporous fluid, in particular water vapor, is injected, so that the nonwoven fabric elements 12a, 12b, 12c, 12d swell and are materially bonded to one another to form an upholstery element 10, and the at least one additional component 14 is materially bonded to the upholstery element 10.

In the simplified representation of step S505, a deformation of the nonwoven fabric elements 12a, 12b, 12c, 12d above the additional component 14 is also illustrated. It should be noted that the nonwoven fabric elements 12a, 12b, 12c, 12d and the additional component 14 shown in steps S501 to S505 are shown in sections and schematically only. The sectional view shown for step S505 shows only a small section of an upholstery element 10.

By swelling (S505) the nonwoven fabric elements 12a, 12b, 12c, 12d in the closed forming tool, a preform or a final shape of the upholstery element 10 is formed.

According to an optional step S506, the upholstery element 10 is cut and/or pressed as a preform inside the forming tool or outside the forming tool in order to produce a final shape of the upholstery element 10.

According to an optional step S507 shown in FIG. 2, an upholstery cover element 16 made of a textile material and/or leather and/or plastic can be attached to the upholstery element 10, wherein the upholstery cover element 16 is fastened by means of multiple upholstery clips 18 to the at least one additional component 14, which is integrally received in the upholstery element 10.

The upholstery clips 18, shown here in simplified form as ellipses, can be made of a flat strip material, in particular flat strip steel.

FIG. 3 shows a simplified and schematic plan view of an upholstery element 10 with an additional component 14 integrally received therein. The additional component 14 is shown as a dashed line.

The additional component 14 can, for example, be a type of frame, for example made of a metal wire or a plastic material. This allows the fastening of a cover element 16 (FIG. 2) circumferentially along the upholstery element 10 or the additional component 14 accommodated therein.

It should be noted that the additional component 14 may also have a different shape than that shown in simplified form in FIG. 3.

From FIG. 3, it is further apparent that an upholstery element 10 produced according to the method 500 described above can be part of a vehicle seat 20, which is illustrated here as a dash-dotted rectangle. Furthermore, FIG. 3 also shows that a motor vehicle 200 can have at least one such vehicle seat 20.

1. A method for producing an upholstery element of a vehicle seat comprising:
providing at least two plate-like nonwoven fabric elements;
inserting one or more nonwoven fabric elements into a forming tool;
inserting at least one additional component made of a plastic and/or a metal and/or a textile on top of the last inserted nonwoven fabric element;
inserting at least one other nonwoven fabric element into the forming tool, wherein the at least one nonwoven fabric element covers the at least one additional component;
closing the forming tool and injecting a vaporous fluid, in particular water vapor, such that the nonwoven fabric elements swell and are materially bonded to one another to form an upholstery element, and the at least one additional component is materially bonded to the upholstery element.

2. The method according to claim 1, wherein a preform or a final shape of the upholstery element is formed by the swelling of the nonwoven fabric elements in the closed forming tool.

3. The method according to claim 2, wherein the upholstery element is cut and/or pressed as a preform in a further step inside the forming tool or outside the forming tool in order to produce a final shape of the upholstery element.

4. The method according to claim 2, wherein an upholstery cover element made of a textile material and/or of a leather and/or of a plastic is attached to the upholstery element, wherein the upholstery cover element is fastened by means of multiple upholstery clips to the at least one additional component which is integrally received in the upholstery element.

5. The method according to claim 4, wherein the upholstery clamp is made of a flat strip material, in particular flat strip steel.

6. A vehicle seat with at least one upholstery element which has been produced according to the method according to claim 1, wherein the upholstery element is a seat cushion and/or a back cushion and/or a cheek pad.

7. Motor vehicle with at least one vehicle seat according to claim 6.

8. The method according to claim 2, wherein an upholstery cover element made of a textile material and/or of a leather and/or of a plastic is attached to the upholstery element, wherein the upholstery cover element is fastened by means of multiple upholstery clips to the at least one additional component which is integrally received in the upholstery element.
